(19) United States
(12) Patent Application Publication
(10) Pub. No.: US 2011/0157821 A1
(43) Pub. Date: Jun. 30, 2011

(54) MOUNTING APPARATUS FOR PCI CARD

(75) Inventors: DING LIU, Shenzhen City (CN); ZHAN-YANG LI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/840,196

(22) Filed: Jul. 20, 2010

(30) Foreign Application Priority Data
Dec. 24, 2009 (CN) 200920318341.8

(51) Int. Cl. G06F 1/16

(52) U.S. Cl. 361/679.58

(57) ABSTRACT

A mounting apparatus includes a bracket and a gripping member secured to the bracket. The gripping member includes a supporting portion and a retaining portion connected to the supporting portion. A first locking tab and a second locking tab are located on the supporting portion. A latch is located on the retaining portion. The retaining portion is moved between a first position, where the latch is engaged between the first and second locking tabs for sandwiching a PCI card between the retaining portion and the supporting portion, and a second position, where the latch is disengaged from the first and second locking tabs.

### BACKGROUND

1. Technical Field

The present disclosure relates to a mounting apparatus for a peripheral component interconnect (PCI) card.

2. Description of Related Art

In a server system, a long PCI card is often used. Usually, opposite ends of the long PCI card should be stably secured for stable operation.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a mounting apparatus and a PCI card in accordance with an embodiment.

FIG. 2 is an isometric view of a gripping member of the mounting apparatus of FIG. 1.

FIG. 3 is another isometric view of the gripping member of FIG. 2, showing a retaining portion in a locked position.

FIG. 4 is an assembled view of the mounting apparatus of FIG. 1, showing the retaining portion in an unlocked position.

FIG. 5 is an assembled view of the mounting apparatus and the PCI card of FIG. 1.

FIG. 6 is similar to FIG. 5, but showing the retaining portion in the locked position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

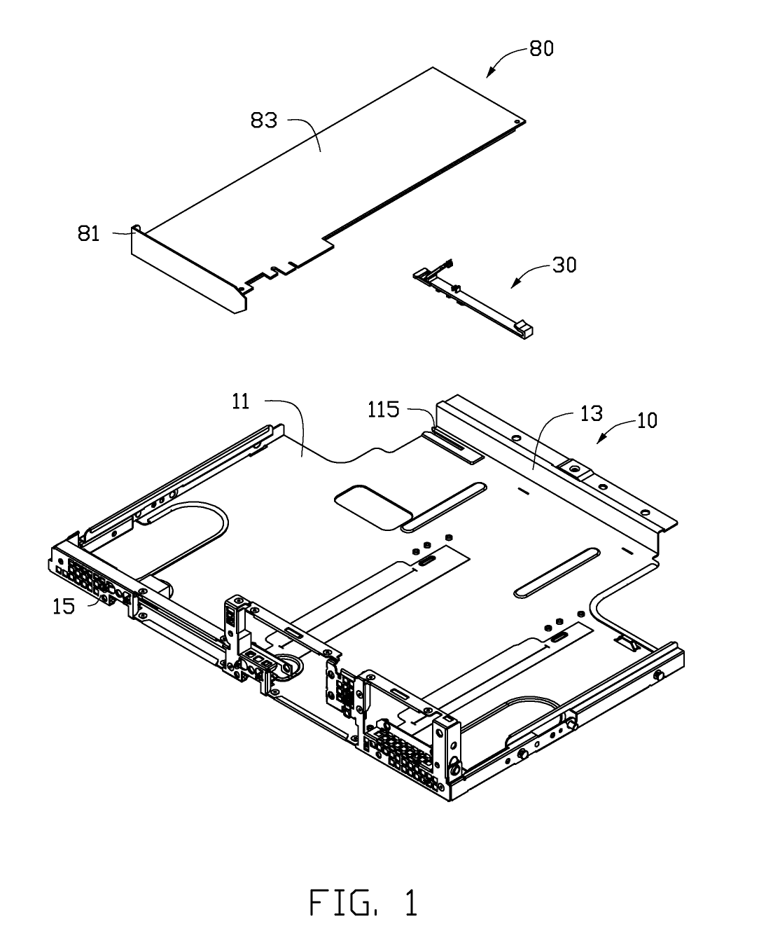

Referring to FIG. 1, a mounting apparatus is configured for securing a peripheral component interconnect (PCI) card 80. The PCI card 80 includes a card body 83 and a mounting plate 81 secured to an edge of the card body 83.

The mounting apparatus in accordance with an embodiment includes a bracket 10 and a gripping member 30.

The bracket 10 includes a base plate 11, a first side plate 13, and a second side plate 15. The first and second side plates 13, 15 are located on opposite edges of the base plate 11. A slit 115 is defined in the base plate 11 adjacent the first side plate 13. In one embodiment, the second side plate 15 is substantially perpendicular to the base plate 11.

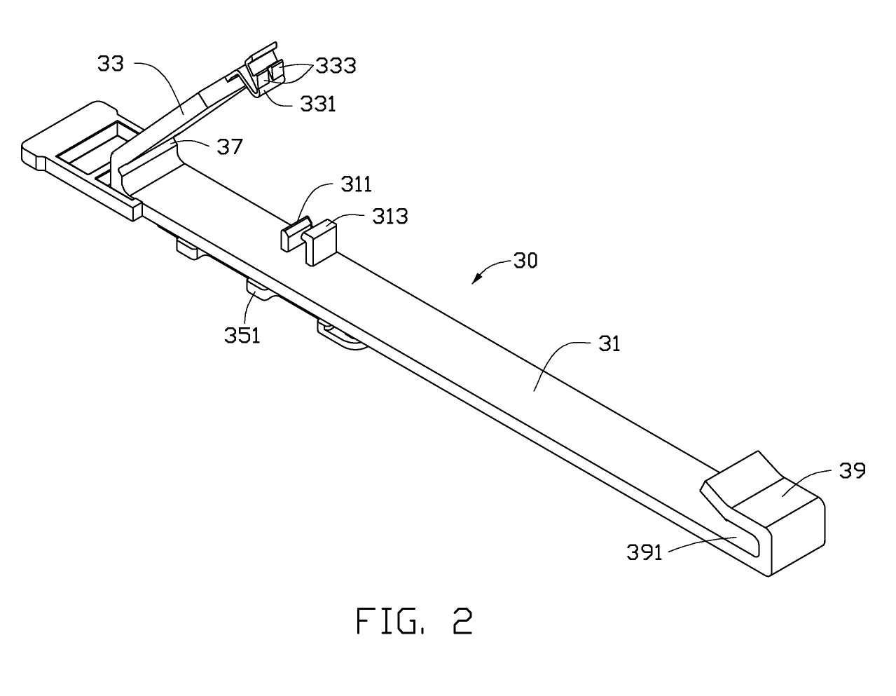

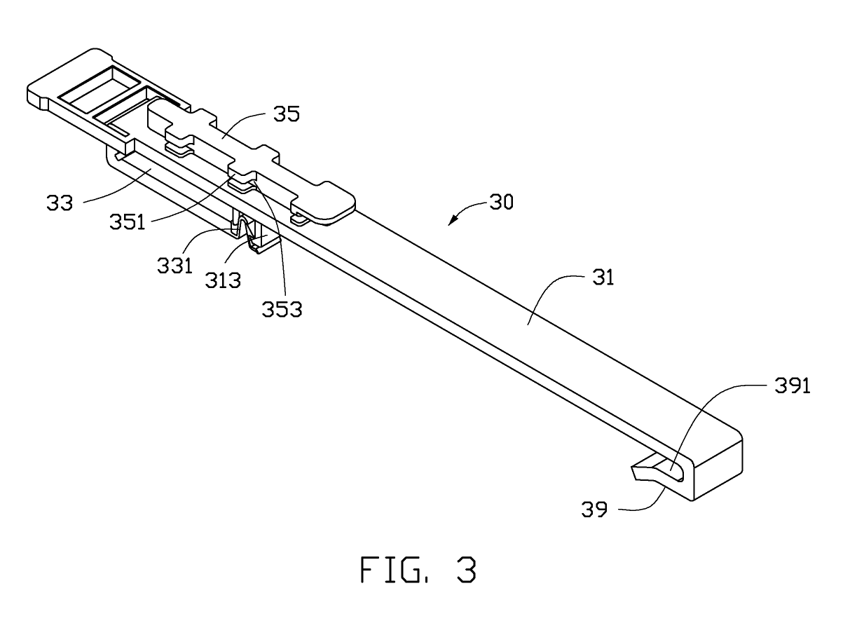

Referring to FIGS. 2-3, the gripping member 30 includes a supporting portion 31, a retaining portion 33, a positioning portion 39, and a locking portion 35. The retaining portion 33 and the positioning portion 39 are located on a first surface of the supporting portion 31 at opposite ends, and the locking portion 35 is located on a second surface of the supporting portion 31 opposite to the first surface. A first locking tab 311 and a second locking tab 313 are located on the first surface of the supporting portion 31 adjacent the retaining portion 33. The retaining portion 33 is connected to the supporting portion 31 and rotatable relative to the supporting portion 31. A latch 331 is located at a distal end of the retaining portion 33 and is resiliently deformable. Two protrusions 333 are located on the latch 331, for engaging with the second locking tab 313. In one embodiment, the latch has a V-shaped section. A cutout 37 is defined in a joint between the retaining portion 33 and the supporting portion 31, for easily rotating the retaining portion 33. A slot 391 is defined between the positioning portion 39 and the supporting portion 31, for receiving the card body 83 of the PCI card 80. The locking portion 35 is adjacent the retaining portion 33 and configured to engage in the slit 115 of the bracket 10. A plurality of pairs of locking tabs 351 is located at two opposite edges of the locking portion 35. A gap 353 is defined between each pair of locking tabs 351 and configured to receive the base plate 11 of the bracket 10.

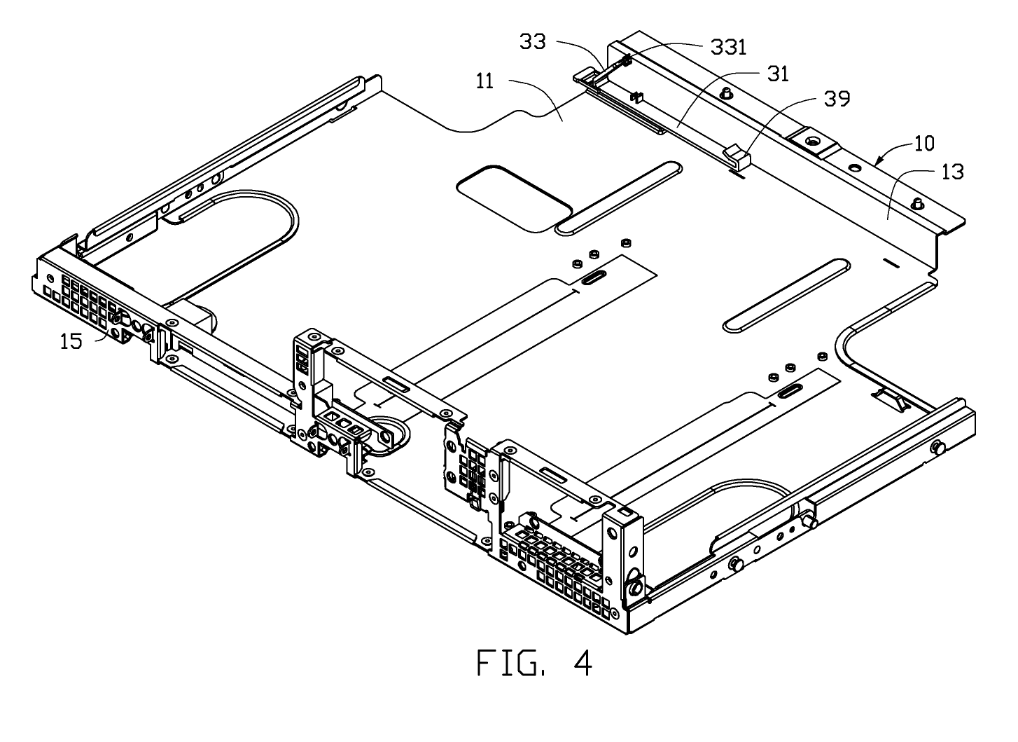

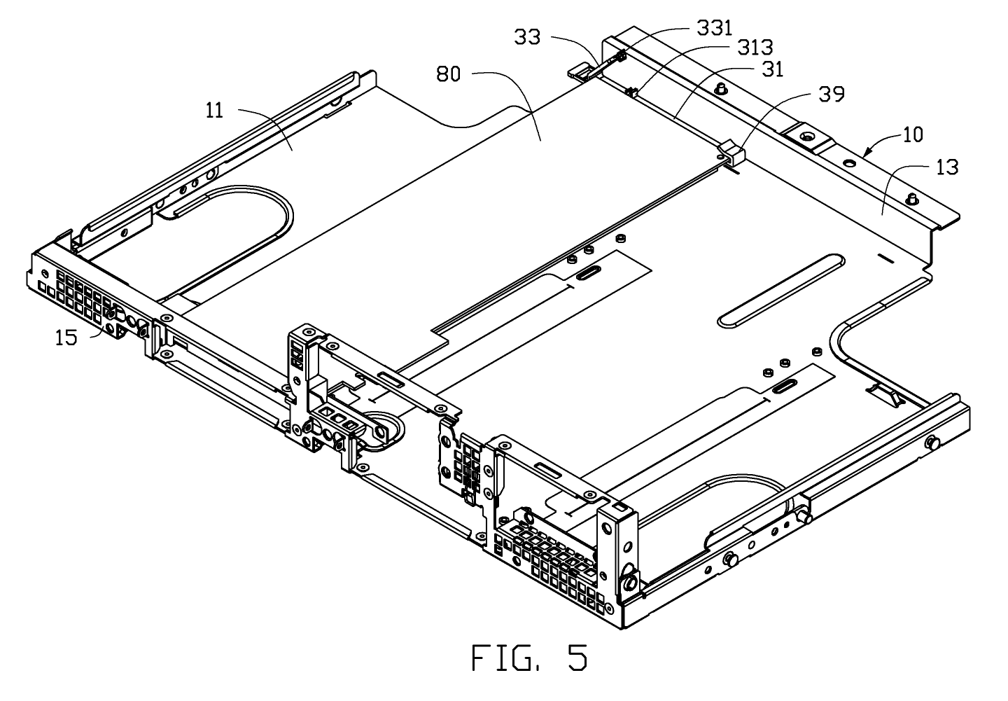

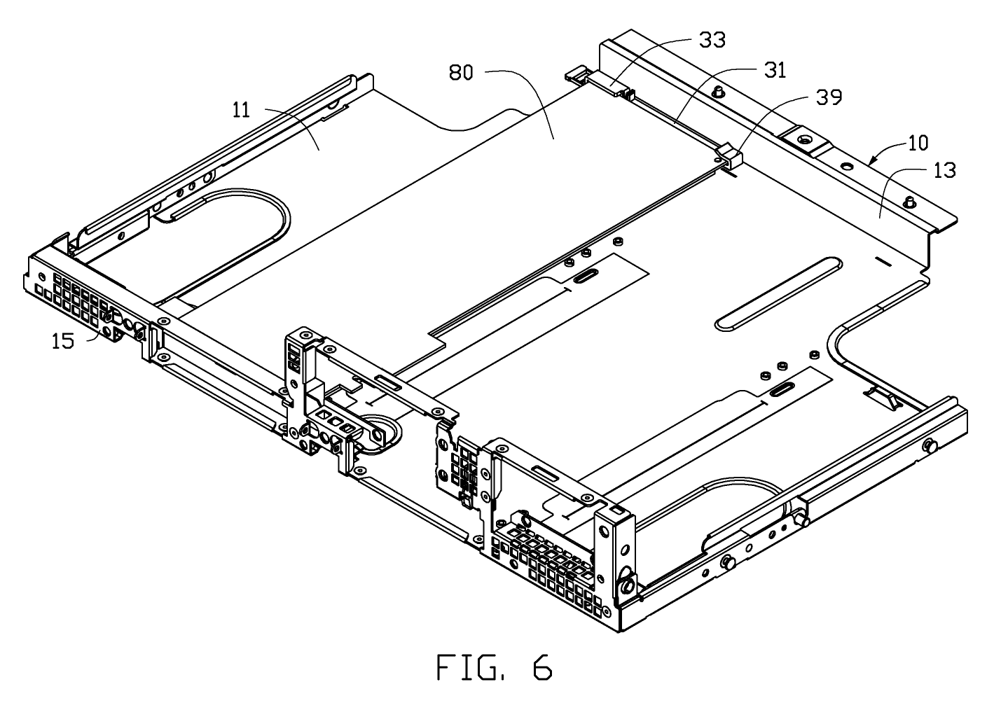

Referring to FIGS. 4-6, in assembly, the gripping member 30 is engaged in the slit 115 of the base plate 11 of the bracket 10. The base plate 11 is engaged in the gaps 353 of the locking portion 35. The protrusions 333 of the latch 331 of the retaining portion 33 are disengaged from the second locking tab 313, and the retaining portion 33 is rotated up. The PCI card 80 is placed in the bracket 10, and the card body 83 is parallel to the base plate 11. The mounting plate 81 is secured to the second side plate 15 with means such as screws. The card body 83 is placed on the supporting portion 31 of the gripping member 30 and engaged in the slot 391. The retaining portion 33 is rotated down to insert the latch 331 between the first and second 311, 313, and the protrusions 333 are engaged with the second locking tab 313. The card body 83 of the PCI card 80 is sandwiched between the retaining portion 33 and the supporting portion 31, and the PCI card 80 is installed in the bracket 10 between the first and second side plates 13, 15.

In disassembly, the latch 331 is resiliently deformed to disengage the protrusions 333 from the second locking tab 313, so the latch 331 can be removed from between the first and second locking tabs 311, 313. The retaining portion 33 is rotated up. The mounting plate 81 of the PCI card 80 is removed from second side plate 15 of the bracket 10, and therefore the PCI card 80 can be removed out of the bracket 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a bracket; and
a gripping member secured to the bracket, the gripping member comprising a supporting portion and a retaining portion connected to the supporting portion; a first locking tab and a second locking tab located on the supporting portion; and a latch located on the retaining portion;
wherein the retaining portion is moved between a first position, where the latch is engaged between the first and second locking tabs for sandwiching a peripheral component interconnect (PCI) card between the retaining portion and the supporting portion, and a second position, where the latch is disengaged from the first and second locking tabs.

2. The mounting apparatus of claim 1, wherein the gripping member further comprises a positioning portion, and a slot defined between the positioning portion and the supporting portion for receiving the PCI card.

3. The mounting apparatus of claim 1, wherein a protrusion is located on the latch; and protrusion is engaged with the second locking tab when the retaining portion is in the first position, and disengaged from the second locking tab when the retaining portion is in the second position.

4. The mounting apparatus of claim 1, wherein the latch is resiliently deformable.

5. The mounting apparatus of claim 1, wherein the retaining portion is rotatable between the first and second positions.

6. The mounting apparatus of claim 1, wherein a joint between the retaining portion and the supporting portion defines a cutout.

7. The mounting apparatus of claim 1, further comprising a bracket, and the bracket defines a slit that receives the gripping member.

8. The mounting apparatus of claim 7, wherein the gripping member further comprises a locking portion that is inserted in the slit.

9. The mounting apparatus of claim 8, wherein the bracket comprises a base plate and a side plate located on and substantially perpendicular to the base plate; the slit is defined the base plate; and the side plate is configured for securing the PCI card.

10. The mounting apparatus of claim 9, wherein a plurality of pairs of locking tabs is located on the locking portion; and the locking portion defines a gap between each pair of locking tabs for receiving the base plate.

11. A mounting apparatus comprising:
a bracket; and
a gripping member secured to the bracket, the gripping member comprising a supporting portion and a retaining portion connected to the supporting portion; and a latch located on the retaining portion;
wherein the retaining portion is rotated between a first position, where the latch is engaged with the supporting portion for sandwiching a peripheral component interconnect (PCI) card between the retaining portion and the supporting portion, and a second position, where the latch is disengaged from the supporting portion.

12. The mounting apparatus of claim 11, wherein the gripping member further comprises a positioning portion and defines a slot between the positioning portion and the supporting portion for receiving the PCI card.

13. The mounting apparatus of claim 11, wherein the latch is resiliently deformable; a locking tab is located on the supporting portion; and the latch is engaged with the locking tab when the retaining portion is in the first position, and disengaged from the locking tab when the retaining portion is in the second position.

14. The mounting apparatus of claim 13, wherein a protrusion is located on the latch; and the protrusion is engaged with the locking tab when the retaining portion is in the first position, and disengaged from the locking tab when the retaining portion is in the second position.

15. The mounting apparatus of claim 13, wherein the latch has a V-shaped section.

16. The mounting apparatus of claim 11, wherein a joint between the retaining portion and the supporting portion defines a cutout.

17. The mounting apparatus of claim 11, further comprising a bracket, and the bracket defines a slit that receives the gripping member.

18. The mounting apparatus of claim 17, wherein the gripping member further comprises a locking portion that is inserted in the slit.

19. The mounting apparatus of claim 18, wherein the bracket comprises a base plate and a side plate located on and substantially perpendicular to the base plate; the slit is defined the base plate; and the side plate is configured for securing the PCI card.

20. The mounting apparatus of claim 19, wherein a plurality of pairs of locking tabs is located on the locking portion; and the locking portion defines a gap between each pair of locking tabs for receiving the base plate.
